(19) United States
(12) Patent Application Publication
(10) Pub. No.: US 2008/0087652 A1
(43) Pub. Date: Apr. 17, 2008

(54) Device for dissipating hot air accumulated in a laser cutter

(75) Inventors: Chung-Ting Chang, Hsi Chih City (TW); Wen-Lung Liang, Hsi Chih City (TW)

Correspondence Address: TROXELL LAW OFFICE PLLC, SUITE 1404, 5205 LEESBURG PIKE, FALLS CHURCH, VA, 22041, US

(73) Assignee: GREAT COMPUTER CORPORATION

(21) Appl. No.: 11/580,283

(22) Filed: Oct. 13, 2006

(51) Int. Cl. B23K 26/10

(52) U.S. Cl. 219/121.82

(57) ABSTRACT

A device for dissipating hot air accumulated in a laser cutter is disclosed. The laser cutter is of a type having a cutting table and a waste collector situated under the cutting table, and the waste collector is provided with a side window. The device includes a wind box having an open back and a plurality of openings defined in a wall thereof, and the wind box is adapted to be attached to the waste collector in such a manner that the open back is positioned at and aligned with the side window of the waste collected. The device further includes a plurality of electric fans arranged on the wind box at the openings. Therefore, air current produced by the electric fans may rush into the waste collector through the wind box and dissipate hot air and scraps fallen into the waste collector under the cutting table.

### FIELD OF THE INVENTION

The present invention relates to a device for dissipating hot air accumulated in a laser cutter and, more particularly, to a device for dissipating hot air accumulated in a laser cutter under a cutting table during the cutting process.

### BACKGROUND OF THE INVENTION

A laser cutter works on a general principle of emitting a laser beam and focusing it on a surface of something to be cut. Absorption of the light energy brings about a high temperature which melts or burns the material at where the laser beam is focused on, so that the material is cut off.

The laser cutter is now widely used for cutting pieces of leather and cloth due to its quickness in cutting and its ability to cut the material along curved lines. However, such laser processing leads to a great number of heat, together with partly burned cutting scraps, which, especially those derived from an flammable material such as leather or cloth, is probably on fire as a result of accumulation of the heat.

Although conventional laser cutters have been provided with means for preventing the cutting scraps from being on fire, their emphasis is still laid only on the dissipation of hot air above a cutting table. In fact, most of the partly burned scraps drop into and deposit in a waste collector situated under the cutting table during the cutting process. These scraps under the cutting table may also be on fire if the air there is heated continuously to such an extend that the temperature there rises to the fire point of the scraps.

Therefore, there is a need for a device to overcome the problem mentioned above.

### OBJECTIVE OF THE INVENTION

It is an objective of the present invention to provide a device for dissipating hot air and scraps in a waste collector under a cutting table during the cutting process.

### SUMMARY OF THE INVENTION

To achieve the aforementioned objective, the present invention provides a device for dissipating hot air accumulated in a laser cutter. The laser cutter is of a type having a cutting table and a waste collector situated under the cutting table, and the waste collector is provided with a side window. The device includes a wind box having an open back and a plurality of openings defined in a wall thereof, and the wind box is adapted to be attached to the waste collector in such a manner that the open back is positioned at and aligned with the side window of the waste collected. The device further includes a plurality of electric fans arranged on the wind box at the openings. Therefore, air current produced by the electric fans may rush into the waste collector through the wind box and dissipate hot air and scraps in the waste collector under the cutting table.

Other objectives, advantages and novel features of this invention will become more apparent from the following detailed description when taken in conjunction with the accompanying drawings.

### BRIEF DESCRIPTION OF THE DRAWINGS

FIG. 1 is an exploded perspective view of a preferred embodiment of a device in accordance with the present invention for dissipating hot air accumulated in a laser cutter;

FIG. 2 is a perspective view showing the inventive device in assembly;

FIG. 3 is a side view showing the inventive device attached to a waste collector of a laser cutter; and

FIG. 4 is a perspective back view showing the inventive device attached to the waste collector of the laser cutter.

### DETAILED DESCRIPTION OF THE PREFERRED EMBODIMENT

The figures show a preferred embodiment of a device constructed in accordance with the present invention for dissipating hot air accumulated in a laser cutter. Although the laser cutter is of a conventional type having a cutting table and a waste collector 31 situated under the cutting table, the waste collector 31 here is provided with a side window (not shown in figures).

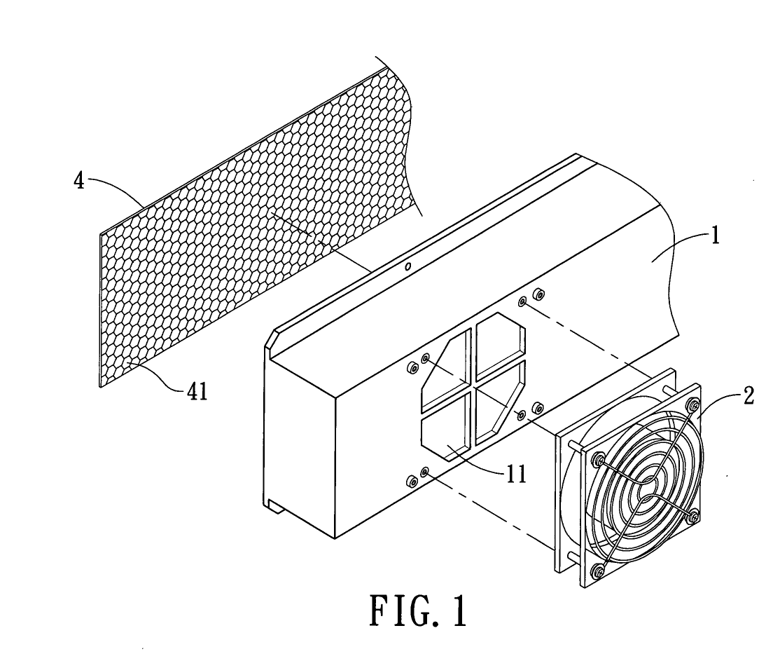

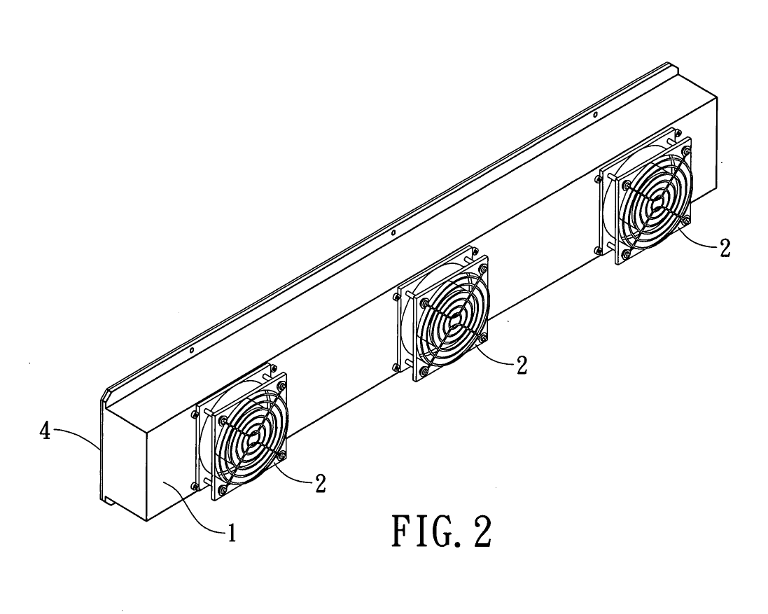

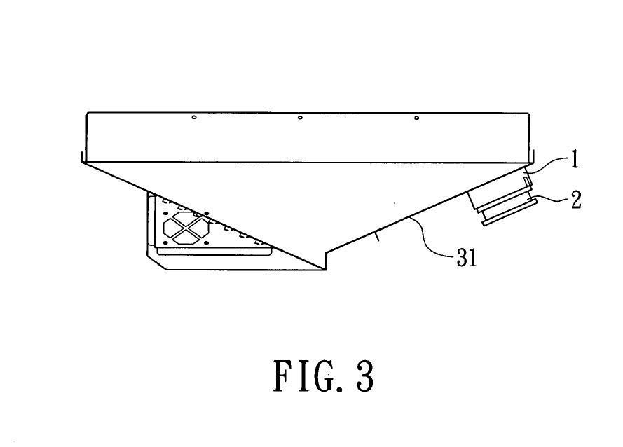

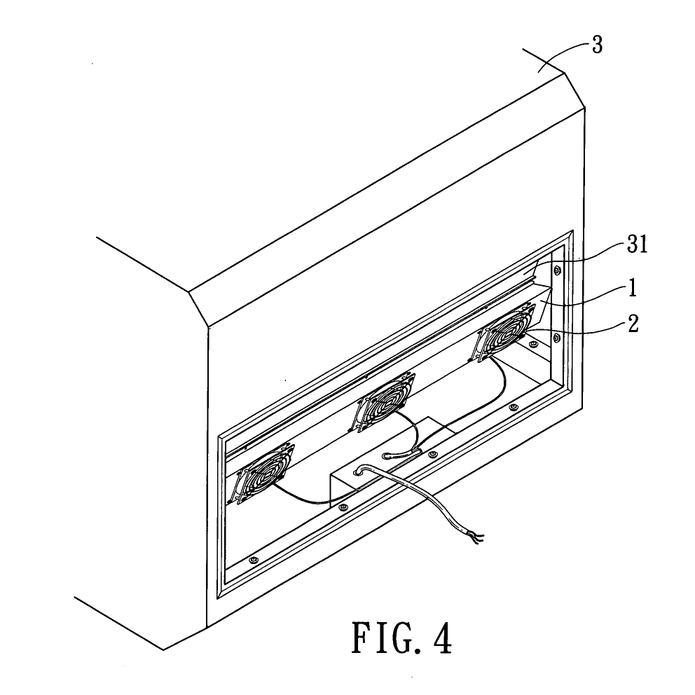

Referring to FIGS. 1 and 2, the inventive device includes a wind box 1 having an open back (not shown) and a plurality of openings 11 defined in a wall thereof, preferred in a wall opposed to the open back. The wind box 1 is adapted to be attached to the waste collector 31 in such a manner that the open back is positioned at and aligned with the side window of the collected 31, as shown in FIGS. 3 and 4.

Arranged on the wind box 1 at the openings 11 is a plurality of electric fans 2 for producing air current. Preferably, a screen plate 4 covers the open back of the wind box 1, and more preferably, the screen plate 4 has a plurality of hexagonal meshes 41 defined therein.

Referring still to FIGS. 1 and 2 and additionally to FIGS. 3 and 4, the inventive device can be assembled by fastening the screen plate 4 to the open back of the wind box 1. Then, the electric fans 2 are arranged on the wind box 1 at the openings 11 after the box 1 is attached to the waste collector 31. Thus, air current produced by the electric fans 2 may rush into the waste collector 31 through the wind box 1 and dissipate hot air and scraps fallen into the waste collector under the cutting table during the cutting process.

From the foregoing, it is apparent that the present invention is advantageous in that:
1. With the inventive device, hot air and scraps fallen into the waste collector under the cutting table during the cutting process can be dissipated quickly and efficiently; and
2. In the inventive device, the screen plate can protect the electric fans from being accidentally shot by the laser beam.

Although embodiments together with structures of the present invention have been described in detail, many modifications and variations may be made from the teachings disclosed hereinabove. Therefore, it should be understood by those skilled in the art that any modification and variation equivalent to the spirit of the present invention be regarded to fall into the scope covered by the appended claims.

What is claimed is:

1. A device for dissipating hot air accumulated in a laser cutter, said laser cutter being of a type having a cutting table and a waste collector situated under said cutting table, said waste collector being provided with a side window, said device comprising:
a wind box having an open back and a plurality of openings defined in a wall thereof, said wind box being adapted to be attached to said waste collector in such a manner that said open back is positioned at and aligned with said side window of said waste collected; and
a plurality of electric fans arranged on said wind box at said openings;
whereby air current produced by said electric fans may rush into said waste collector through said wind box and dissipate hot air and scraps fallen into the waste collector under said cutting table.

2. The device as claimed in claim 1 further including a screen plate covering said open back of said wind box.

3. The as claimed in claim 2, wherein said screen plate has a plurality of hexagonal meshes.
